(19) United States
(12) Patent Application Publication
(10) Pub. No.: US 2012/0084966 A1
(43) Pub. Date: Apr. 12, 2012

(54) METHOD OF MAKING AN INTERACTIVE KEYBOARD

(75) Inventors: Glen C. Larsen, Issaquah, WA (US); Kurt Allen Jenkins, Sammamish, WA (US)

(73) Assignee: MICROSOFT CORPORATION, Redmond, WA (US)

(21) Appl. No.: 13/039,710

(22) Filed: Mar. 3, 2011

Related U.S. Application Data
(63) Continuation-in-part of application No. 12/900,389, filed on Oct. 7, 2010.

(51) Int. Cl. B29C 65/64; B29C 39/02

(52) U.S. Cl. 29/527.1

(57) ABSTRACT

Various methods of making an interactive keyboard in which a plurality of mechanically-depressible keys are situated over a display device, each of the mechanically-depressible keys being configured to permit through-key viewing of images produced by the display device, is provided. One example method includes providing a mold which defines a mold cavity. The method further includes introducing keycap material into the mold cavity. In such an example, the keycap material and the mold interact to produce a molded keycap having a viewing portion with one or more optical layers that are at least partially see-through and configured to provide one or more optical effects in connection with light that is incident upon the one or more optical layers.

### CROSS REFERENCE TO RELATED APPLICATIONS

This application is a continuation-in-part of U.S. patent application Ser. No. 12/900,389, filed Oct. 7, 2010, the entirety of which is hereby incorporated herein by reference.

### BACKGROUND

Keyboards and other peripheral input devices are continually being refined to expand functionality and provide quality user experiences. One area of improvement has been to combine input and output capability in a peripheral device. For example, virtual keyboards have been incorporated using touch interactive displays to provide a more adaptive input experience. In this case, the display capability is provided directly on the keys: each key typically is displayed by the touch interactive display with a legend or symbol that indicates its function. The virtual keyboard approach has many benefits, including the ability to dynamically change the display and function for each key. However, interactive touch displays are often less desirable from a pure input standpoint. Specifically, touch displays do not provide tactile feedback, which can provide a more responsive and agreeable typing experience. Therefore, in many peripheral devices, tradeoffs are made between tactile response and dynamic functionality. Typically, when touch interactivity is provided in connection with a tactile keyboard, the touch interactivity is provided on a different portion of the device and is used for functionality other than keyboard-type inputs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computer peripheral configured to receive tactile user input via mechanical key depression and provide dynamic display output, such as an interactive keyboard, is provided. The computer peripheral includes a display device and a plurality of mechanically-depressible keys situated over the display device. Each of the mechanically-depressible keys is at least partially see-through to permit through-key viewing of imagery generated by the display device. Additionally, each of the mechanically-depressible keys includes an optical element, such as an optical layer, spaced from an operative surface of the display device and configured to adjust viewer perception of image light emanating from the display device through the mechanically-depressible key. Each of the mechanically-depressible keys further includes a mechanical understructure that enables reciprocating up and down movement of the molded keycap relative to the display device.

In one example, a method for making the interactive keyboard is provided. The method includes providing a mold which defines a mold cavity, and introducing keycap material into the mold cavity. The keycap material and the mold may interact to produce a molded keycap having a viewing portion with one or more optical layers which provide one or more optical effects in connection with light that is incident upon the one or more optical layers. The method further includes coupling the molded keycap to the display device via the mechanical understructure.

In some embodiments, the optical layer may include at least one of the following components: a diffuser, a turning film, and a light control film. Specifically in some embodiments a layered construction may be utilized in which two or more of the aforementioned components are included as layers in the optical element. Various viewing characteristics of the computer peripheral may be improved when the aforementioned components are included in the optical element. In particular, the diffuser may act as a “screen” on which light from the display device is projected. Therefore, the display device may project light onto the diffuser and the diffuser may then scatter the incident light, thereby increasing viewability (e.g., the range of viewing angles) as well as create the perception that the viewable image plane is on or near the top of the key. Moreover, the turning film may improve the ability of a user to see image light projected from the underlying display device by increasing the effective viewable area of display device that may be seen through a particular key. Furthermore, the light control film may provide various benefits, including increased image contrast, suppression of ambient light and, in some implementations, increased privacy by constraining the angle from which the key imagery may be viewed. The improved contrast may be particularly beneficial when a high amount of ambient light is present, such as when the peripheral device is used in an outdoor setting. In this way, the computer peripheral's optical characteristics may be enhanced via the optical element.

### BRIEF DESCRIPTION OF THE DRAWINGS

FIG. 1 depicts an exemplary computing system including a keyboard that provides the ability to display output in connection with the keys of the keyboard.

FIG. 2 shows an illustration of the keyboard of FIG. 1 in which mechanically-depressible keys are attached to a display device.

FIG. 3 depicts an example of the output display capability that may be employed in connection with the keyboard of FIGS. 1 and 2.

FIG. 4 is an exploded cross-sectional view of an example key included in the keyboard shown in FIGS. 1 and 2, with the figure also showing portions of an underlying electrical trace network and display device.

FIG. 5 is a cross-sectional view of an example key and an optical element disposed therein included in the keyboard shown in FIGS. 1 and 2.

FIG. 6 is a cross-sectional view of a light ray projected through an optical element included in an example key included in the keyboard shown in FIGS. 1 and 2.

FIGS. 7-12 show various example constructions of an optical element included in the key shown in FIGS. 5 and 6.

FIG. 13 depicts an exemplary method for making a computer peripheral.

FIGS. 14-16 show exploded cross-sectional views of exemplary molds for making a keycap.

FIG. 17 depicts an exemplary method for making a computer peripheral.

FIGS. 18-20 depict exemplary methods for introducing keycap material into a mold so as to create a molded keycap with a viewing portion providing an optical effect.

FIG. 21 shows a schematic depiction of a computing system that may be used in connection with the keyboard/peripheral embodiments discussed herein.

### DETAILED DESCRIPTION

The present disclosure is directed to a computer peripheral, such as an interactive keyboard, configured to receive tactile user input via mechanical key depression and provide dynamic display output. The computer peripheral includes a display device and a plurality of mechanically-depressible keys situated over the display device. Each of the mechanically-depressible keys is at least partially see-through to permit through-key viewing of imagery generated by the display device. Each of the mechanically-depressible keys includes an optical element spaced from an operative surface of the display device and configured to: (i) adjust viewer perception of image light emanating from the display device through the mechanically-depressible key and/or (ii) disrupt upwardly-directed collimated light from the display device to enhance oblique-angle through-key viewing of image light from the underlying display. Each of the mechanically-depressible keys further includes a mechanical understructure that enables reciprocating up and down movement of the molded keycap relative to the display device.

One example method for making the interactive keyboard includes providing a mold which defines a mold cavity, and introducing keycap material into the mold cavity. The keycap material and the mold may interact to produce a molded keycap having a viewing portion with one or more optical layers which provide one or more optical effects in connection with light that is incident upon the one or more optical layers. The method further includes coupling the molded keycap to the display device via the mechanical understructure.

The optical layer may include at least one of the following components: a diffuser, a turning film, and a light control film. Specifically in some embodiments a layered construction may be utilized in which two or more of the aforementioned components are included as layers in the optical element. The component(s) of the optical element may provide several benefits. For example, the diffuser may be configured to scatter light projected from the display device, thereby increasing the viewing angle of the projected imagery as well as creating the perception that the viewable image plane is located at the top of the key. Furthermore, the turning film may increase the viewing angle of the projected imagery allowing a user to view the projected imagery in a number of different postures and/or from various vantage points. Additionally, the light control film may have several benefits such as reducing reflection of ambient light, thereby reducing glare as well as increasing image contrast.

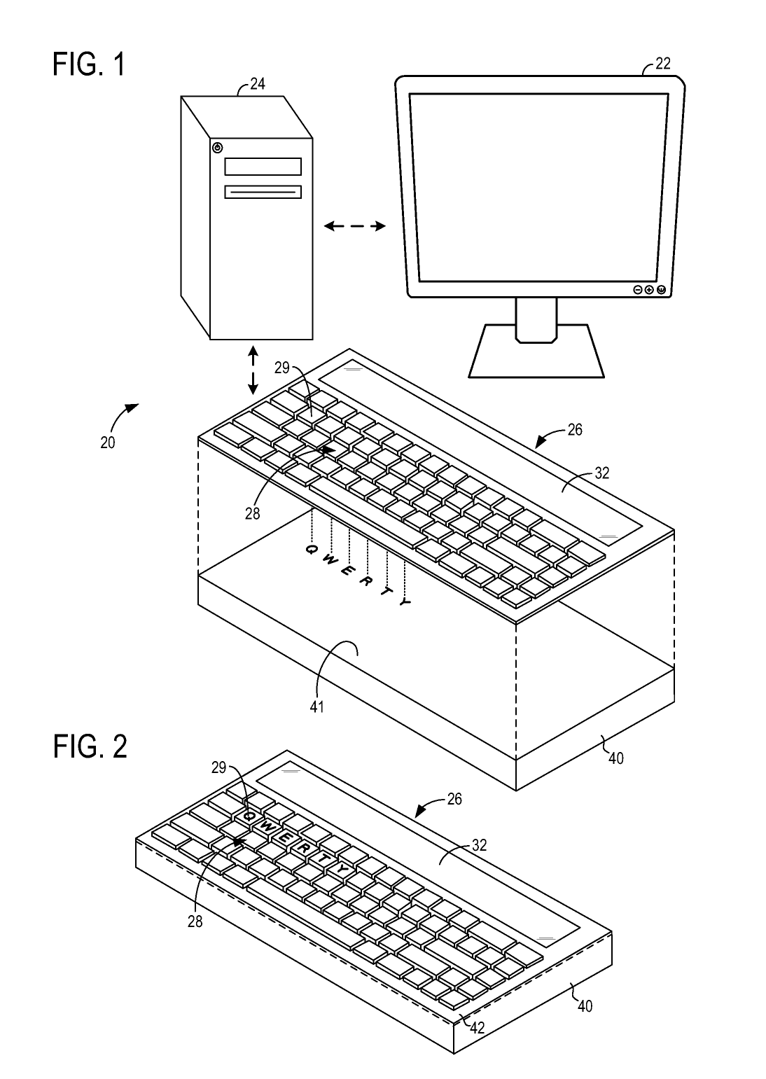

FIG. 1 depicts an exemplary computing system 20 including a display monitor 22 for providing visual output, a computing device in the form of component enclosure 24 (e.g., containing a processor, memory, hard drive, etc.), and a computer peripheral in the form of keyboard 26. Display monitor 22 may be referred to as a primary display. The component enclosure may be in wired/wireless communication with the display monitor and/or the keyboard. FIG. 2 provides an additional view of keyboard 26 and exemplary components that may be used in its construction. As will be described in various examples, keyboard 26 may be implemented to provide displayable output in addition to keyboard-type input functionality.

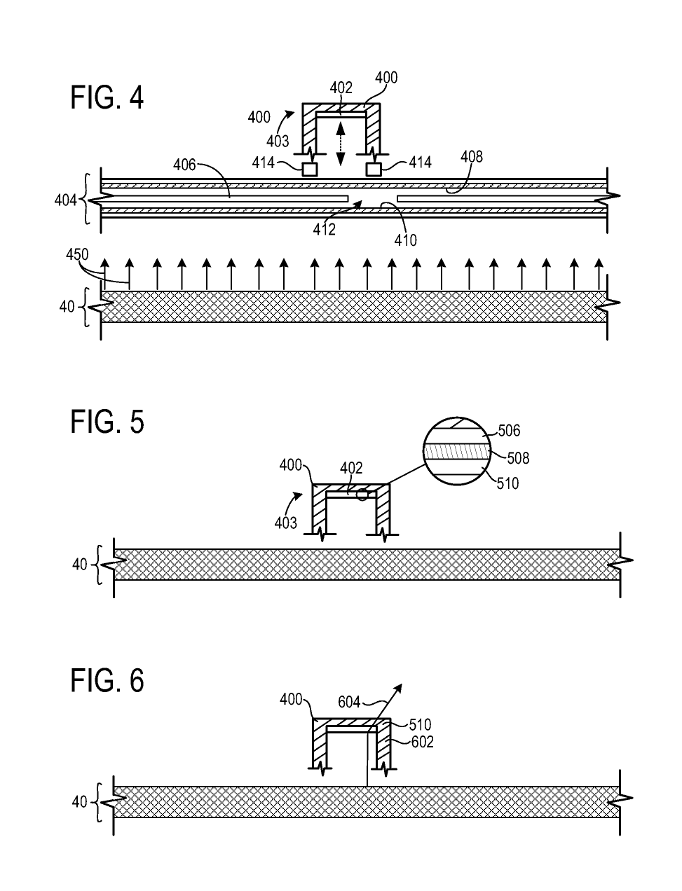

In some examples, displayable output of the keyboard is provided from a suitable display device 40, such as a liquid crystal display (LCD) device, having an operative surface 41. Display device 40 may be referred to as a secondary display. The image light from the display device is viewed through mechanically-depressible keys disposed over the top of the display device. It will be appreciated that each mechanically-depressible key may include a viewing window or be otherwise configured to permit image light from the underlying display device to pass through the keys for viewing by a user. Thus in some examples, each mechanically-depressible key may be at least partially constructed out of a see-through material (e.g., a transparent or partially transparent material), thereby enabling light to be projected through the key. The size and geometry of the viewing window may be selected based on the desired viewing characteristics of the computer peripheral. Specifically, it may be desirable to maximize and optimize the ability to view image light emanating through the keys from the underlying display device, in some examples. However various factors such as the size and geometry of opaque understructures and components {e.g., mechanical understructures (not shown) for providing movement of the mechanically-depressible keys, electrical traces, etc.} may impose constraints on the user's ability to view image light emanating through the keys. Therefore, an optical element configured to enhance through-key viewing may be provided in each of mechanically-depressible keys 28 to at least partially overcome the aforementioned constraints. The optical element is discussed in greater detail herein with regard to FIGS. 4-12.

Continuing with FIG. 1, individual keys may be depressed to provide inputs, for example, in the form of electrical signals to control computing system 20. The terms “input” and “output” will be used frequently in this description in reference to example keyboard embodiments. When used in connection with a keyboard key, the term “input” will generally refer to the input signal that is provided by the keyboard in response to operation of the key. “Output” will generally refer to the display provided for a key, such as the displayed legend, icon, or symbol that indicates the function of the key.

As indicated by the “Q”, “W”, “E”, “R”, “T”, “Y”, on keys 28 (FIGS. 1 and 2), it will often be desirable that keyboard 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, keys 28 of the keyboard may be variously configured to provide other inputs. Keys may be assigned, for example, to provide functionality for various languages and alphabets, and/or to activate other input commands for controlling computing system 20. In some implementations, the key functions may adapt and/or change dynamically, for example in response to the changing operational context of software running on computing system 20. For example, upon pressing of an “ALT” key, operation of a key that otherwise is used to enter the letter “F” might instead result in activation of a “File” menu in a software application. Generally, it will be understood that the keys in the present examples may be selectively depressed to produce any type of input signal for controlling a computing device.

Keyboard 26 can provide a wide variety of displayable output. In some examples, the keyboard causes a display of viewable output on or near the individual keys 28 to indicate key function. This can be seen in FIGS. 1 and 2, where instead of keys with letters painted, printed or etched onto a keycap surface, display device 40 (e.g., an LCD device situated under the keys) is used to display the “Q”, “W”, etc., functions of the keys. This dynamic and programmable display capability facilitates potential use of keyboard 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided does not have to be associated with the input functionality of the keyboard. Images might be provided, for example, for aesthetic purposes, to personalize the user experience, or to provide other types of output. The present disclosure encompasses display output for any purpose, including purposes other than to indicate the function of particular keys.

Also, in addition to display provided on or near keys 28, display functionality may be provided in other areas, for example in an area 32 located above keys 28. Still further, area 32 or other portions of keyboard 26 may be provided with touch or gesture-based interactivity in addition to the keyboard-type input provided by keys 28. For example, area 32 may be implemented as an interactive touchscreen display, via capacitive-based technology, resistive-based technology, or other suitable methods. Also, as described elsewhere herein, the portion of the device that underlies the keyboard may also include capabilities in addition to display, including touch sensitivity, machine vision and the like.

Turning now to FIG. 2, keyboard 26 may include underlying display device 40 and a keyboard over-structure 42 disposed over and secured to the display device. The keyboard over-structure may include keys 28, a plurality of mechanical structures which may be disposed under keys, and/or an electrical trace network. Keys 28 are mechanically movable toward and away from underlying display device 40. Underneath keys 28 is an electrical trace network (not visible in the figure) that provides electrical signals in response to depression of keys 28. Alternatively, as mentioned above, output signals may result from touch interaction of the keys with the display device or through other appropriate mechanisms. Specifically, in some examples, output signals may be generated in response to optical sensing of mechanical key depression. In other words, an optical sensing subsystem (not shown) using machine vision may be employed to generate output signals responsive to mechanical key depression.

A variety of types of display devices may be employed in keyboard 26. As indicated briefly above, one type of suitable display device is an LCD device. References to an LCD or other specific type of display device are non-limiting; the keyboard examples discussed herein may include any display type suitable for use with overlying mechanically-depressible keys.

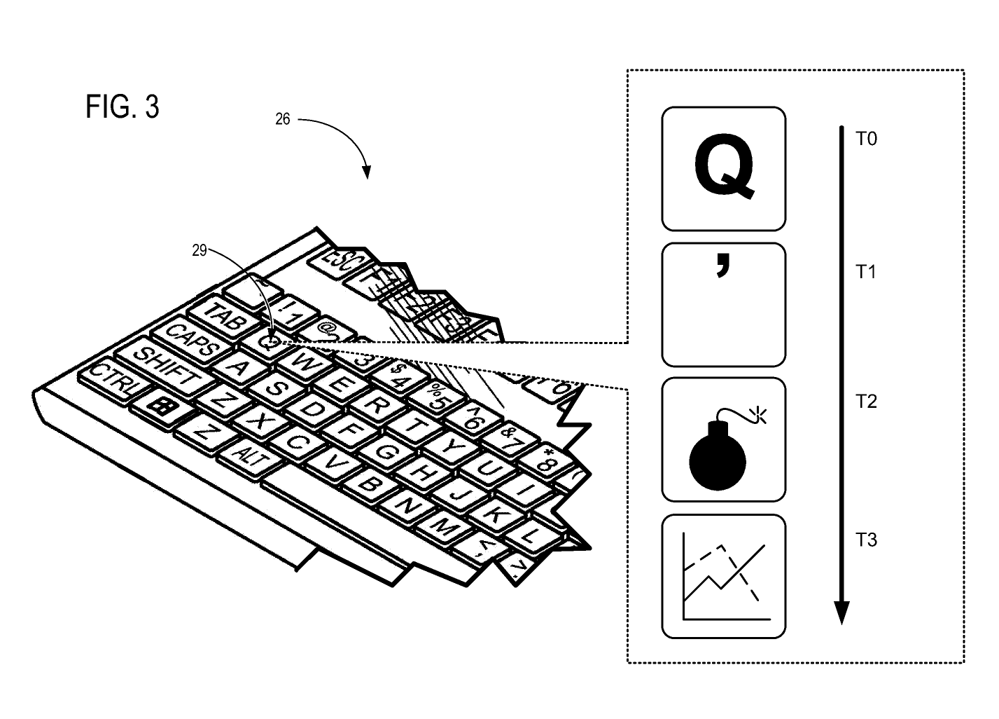

FIG. 3 provides further illustration of how the display capability of keyboard 26 may be employed in connection with an individual key 29. In particular, as shown respectively at times T0, T1, T2, etc., the display output associated with key 29 may be changed, for example to reflect the input command produced by depressing the key. However, as previously mentioned, the viewable output provided by the keyboard may take forms other than displays associated with individual keys and their input functionality.

As indicated above, it will normally be desirable to maximize and optimize the ability to view image light emanating through the keys from the underlying display device. Design goals may include increasing contrast, suppressing ambient light, increasing the viewable area of the underlying display and/or providing privacy through constraining viewing angles, to name a few examples.

To enhance optical performance and/or variously provide the above advantages, each of the mechanically-depressible keys may be provided with an optical element configured to adjust viewer perception of the image light from the display device and/or to disrupt the upwardly-directed collimated light produced by the display device.

FIG. 4 schematically depicts a cross section of a mechanically-depressible key including a keycap 400 and a mechanical understructure 414 situated over display device 40, the mechanically-depressible key including optical element 402. Optical element 402 may be generally located within or near a viewing portion 403 of keycap 400 and may have the form of an optical layer. It will be appreciated that keycap 400 provides an example implementation that may be used with some or all of the keys shown in the other figures of the present application. Relative dimensions in the figure are for the purposes of illustration and clarity only; actual dimensions may vary from those in the figure.

In the example of FIG. 4, a mechanical understructure 414 is provided below keycap 400. The mechanical understructure 414 enables reciprocating up and down movement of the key relative to the display device 40. In this manner, the viewing portion 403 of the keycap 400 is spaced away from the display device 40 and operative to provide the optical effect for imagery generated by the display device. In some examples, the mechanical understructure may be a scissors structure adapted to constrain the key to generally perpendicular linear movement toward and away from the base structure of the keyboard assembly. In other examples, the mechanical understructure may be a mechanical hinge or a spring.

In the example of FIG. 4, an electrical trace network 404 is provided below keycap 400. Depression of the key produces a resilient deformation in which an viewing portion 408 of the trace network is brought into contact with a lower portion 410 through a hole 412 in insulating layer 406. The resulting contact causes generation of an output signal associated with the key. It will be understood, however, that this is but one example of how an output signal may be generated. Many other approaches are possible without departing from the scope of the current discussion. For example, an optical sensing subsystem using machine vision may be used to detect key actuation. The figure also shows upwardly-directed image light 450 emanating from display device 40. This image light passes through the key to provide through-key viewing of image light, such as, for example, a display indicating the function of the key.

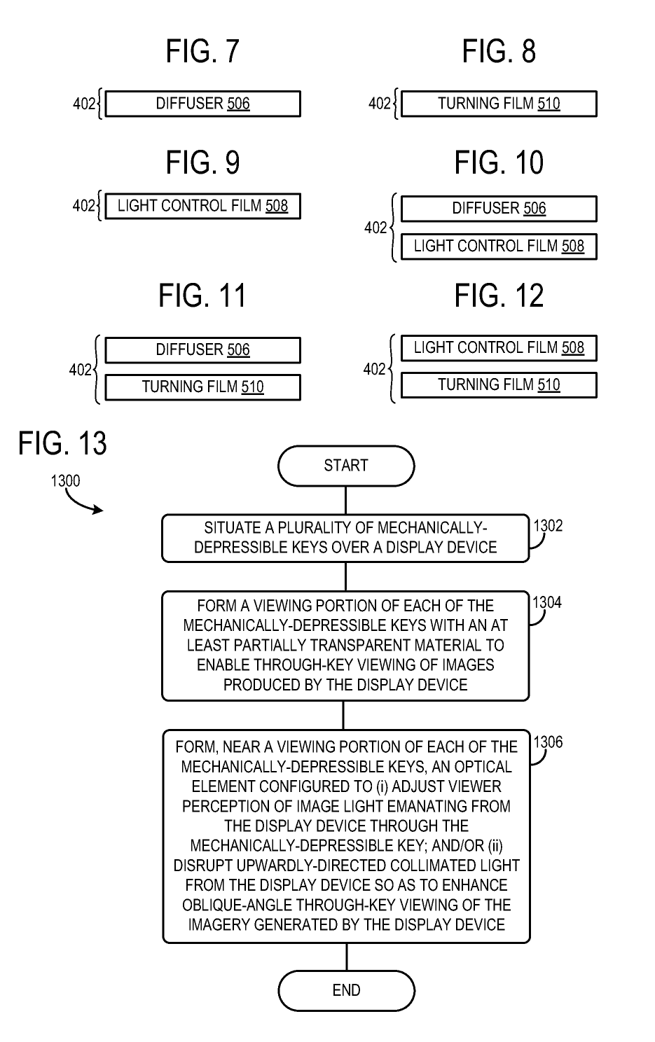

As briefly mentioned above, a viewing portion of the key may include an optical element to enhance through-key viewing of image light. Specifically as indicated in FIG. 4 and in more detail in FIG. 5, optical element 402 may be generally located within or near viewing portion 403 of keycap 400. FIG. 5 shows that the optical element may be formed in a layered construction, including a diffuser 506, light control film 508 and turning film 510. As shown, the diffuser is positioned above the light control film which is positioned above the turning film. However, the number as well as the stacking order of the layers may be altered in other examples, discussed in greater detail with regard to FIGS. 7-12. These layers may be formed using any appropriate manufacturing method or technique, such as molding, adhesively bonding, ultrasonically welding, etc. Moreover, the layers (i.e., diffuser, light control film, and turning film) may be disposed in various locations near the viewing portion of the key. Though the specific location and structure may vary, it typically will be desirable that the layer or layers (in some cases, there may be only one or two of the depicted layers) be positioned at a location spaced away from operative surface 41 of the underlying display device 40, shown in FIG. 1. However, in other examples one or more of the layers may be disposed on or near operative surface 41 of display device 40, shown in FIG. 1, while one or more of the other layers may be spaced away from the operative surface and positioned in keycap 400. In such a configuration, the layer(s) disposed on or near the operative surface may optically interact with the layer(s) spaced away from the operative surface to provide enhanced optical capabilities, discussed in greater detail herein.

The depicted layers may provide various advantages in connection with improving the user viewing experience of images produced by the underlying display device. For example, diffuser 506 enables the system to act as a projection device in which the diffuser provides a “screen” onto which light from the display device is projected. The incident collimated light is then scattered, increasing viewability (e.g., range of viewing angles) and creating the perception that the viewable image plane is located on the plane of the diffuser, near the top of the key. In this way the diffuser is configured to disrupt upwardly-directed collimated light from the display device so as to enhance oblique-angle through-key viewing of the imagery generated by the display device.

The light control film 508 may provide various benefits, including increasing image contrast, suppressing ambient light and, in some implementations, increasing privacy by constraining the viewing angle that enables a user to see the images passing through the keys. The light control film acts like a venetian blind in which the slats are oriented at a particular angle, thereby favoring transmission in certain directions while absorbing other light. In certain implementations, this suppresses ambient light and/or provides improved contrast. Improved contrast may be particularly beneficial when a high amount of ambient light is present, such as when the peripheral device is used outdoors. Privacy may also be obtained through use of the light control film by limiting viewing angles from which images from display device 40 may be seen.

Turning film 510 may improve the ability of a user to see image light from the underlying display device by increasing the effective viewable area of display device that may be seen through a particular key. In particular, the typical vantage point of the user is at an angle to the planar expanse of display device. This angle will vary depending on the user's position, and may range from a few degrees to 45 degrees or more, such as when the keyboard is situated on a desk in front of the user. In this arrangement, the turning film refracts the incident light toward the user's eye. This bending effect allows the user to see portions of the display device that otherwise would be obscured, for example by a front wall of one of the mechanically-depressible keys. Moreover, the refraction angle of the turning film may be selected to enable a user to maintain an ergonomic posture while viewing the imagery projected from the underlying display device as well as executing mechanical key inputs (e.g., depression of the keys). Further, it will be appreciated that the angle of refraction in turning film 510 may also be selected based on the end use of the device. For example, different angles may be used for a computer peripheral integrated into a component enclosure of a laptop computer as opposed to a computer peripheral used in conjunction with a desktop computer. In this way, the optical element may be adapted for use with a variety of computer peripherals.

FIG. 6 schematically shows use of turning film 510 to enable viewing of image light that would otherwise be obscured by front wall portion 602 of the depicted key structure. In some examples (not shown), the feature labeled turning film 510 may be a single turning prism. However, in other examples turning film 510 may include a plurality of microprisms or other suitable structures configured to refract light. Although the optical element is shown only including a turning film it will be appreciated that additional or alternative layers may be included in the optical element, as described below. As shown the angle of light ray 604 may be refracted when projected through keycap 400, thereby enabling viewing of image light at a different angle.

It will be further understood that different applications may call for different layered configurations of optical element 402 shown in FIGS. 4 and 5, including single-layer implementations, as shown in FIGS. 7-9. FIG. 7 shows the optical element including diffuser 506 only, FIG. 8 shows the optical element including turning film 510 only, and FIG. 9 shows the optical element including a light control film 508 only. Example dual layer implementations are shown in FIGS. 10-12. Specifically FIG. 10 shows the optical element including diffuser 506 and light control film 508, FIG. 11 shows the optical element including diffuser 506 and turning film 510, and FIG. 12 shows the optical element including light control film 508 and turning film 510. As previously discussed a triple layer implementation may be utilized as shown in FIG. 5. Moreover, in the dual and triple layers configurations the layers may be positioned in any suitable stacking sequence. The arrangement of the layers may be selected to achieve varying benefits. For example, privacy considerations may dictate using the light control film as the top-most layer, to maximize its angle-selective transmission. In another example, the diffuser may be positioned above other layers in the optical element, to prevent the diffuse light from optically interfering with the optical characteristics of the other layers. Specifically, the diffuser may be the top-most layer. Moreover, the turning film may be the layer positioned closest to the display device, due to the fact that the turning film may not significantly affect the optical characteristics of the other layers.

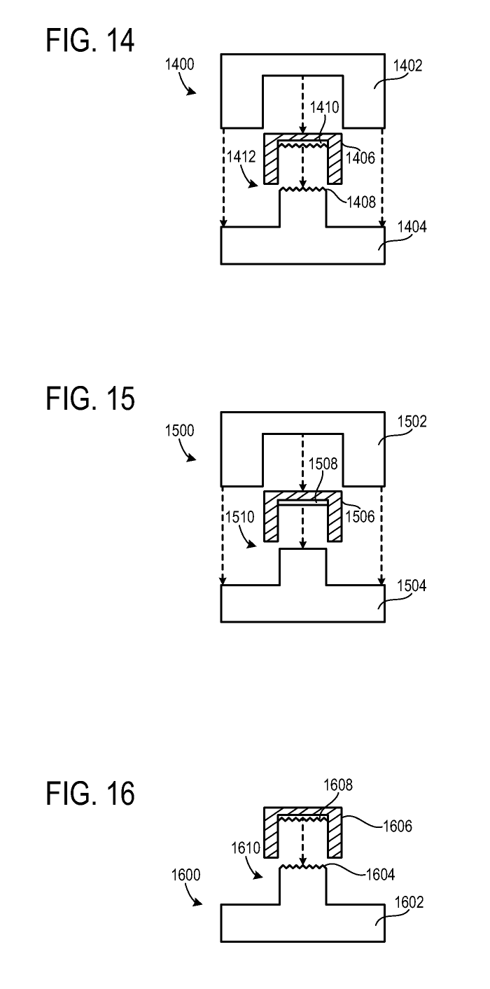

Various manufacturing techniques may be employed for optical element 402. The various layers may be bonded through ultrasonic or pressure-sensitive adhesive methods; formed through printing, deposition or other like techniques; and/or formed using molding processes, including co-molding, overmolding or unified molding processes, as will be described in greater detail with regard to FIGS. 14-20. The layers may be affixed to a separate transparent layer or portion, such as a keycap made of polycarbonate or acrylic (for example), or may be formed without a separate transparent material. Moreover, one or more layers within the optical element may be embossed. Specifically the turning film may be micro-embossed.

It will be further appreciated that the present disclosure contemplates a method of making a computer peripheral, such as an interactive keyboard with dynamic display output and through-key viewing in connection with mechanically-depressible keys. Such a method might include, as shown in connection with exemplary method 1300 of FIG. 13, situating a plurality of mechanically-depressible keys over a display device (step 1302). The method may further include forming a viewing portion of each of the mechanically-depressible keys with an at least partially transparent material to enable through-key viewing of images produced by the display device, as shown at 1304. Finally the method may include at 1306, forming, near a viewing portion of each of the keys, an optical element to (i) adjust viewer perception of image light and/or (ii) disrupt upwardly-directed collimated light from the underlying display device to enhance oblique-angle through-key viewing of the imagery generated by the display device. The optical element may include at least one of a diffuser, a turning film, and a light control film, to optically enhance the computer peripheral as previously discussed. In this way, a computer peripheral with enhanced viewing characteristics may be constructed.

FIG. 14 shows an exploded cross-sectional view of an example of a mold 1400 for making a keycap, where a molded keycap 1406 produced by the mold 1400 is included inside the mold 1400. The mold 1400 includes a first portion 1402, which forms the cosmetic surfaces of the keycap, and a second portion 1404 which define a mold cavity 1412 when brought together. In the example of FIG. 14, material may be injected into the mold to form the keycap 1406. As an example, the material may be polycarbonate, acrylic, or the like. In this manner, a keycap formed with the mold 1400 is injection molded.

Further, in the example of FIG. 14, the second portion 1404 of the mold may form or include an optical pattern 1408 configured to yield an optical layer 1410 in the keycap 1406 as a result of the injection molding process. As an example, the second portion 1404 of the mold may form a series of prisms in the keycap 1406 which enhance oblique-angle through-key viewing of the imagery generated by the display device. For example, the second portion 1404 of the mold may form a turning film or layer in the underside of the viewing portion of the keycap 1406 when the material is injected in the mold cavity 1412. The prisms/patterns may be variously configured to provide a desired amount of turning (e.g., a particular angle), to accommodate the fact that a user normally views the keycaps from an angle instead of looking straight down through the key to the underlying display device.

In some examples, one or more optical layers may be pre-inserted in the mold cavity 1412 such that material injected into the mold cavity 1412 bonds with the one or more optical layers. For example, a diffusing layer and/or a light control layer, among other optical-effect generating layers, may be pre-inserted into mold cavity 1412 in viewing portion 1402 of the mold so as to provide effects in addition to the turning provided by pattern 1408.

FIG. 15 shows an exploded cross-sectional view of an example of a mold 1500 for making a keycap, where a molded keycap 1506 produced by the mold 1500 is included inside the mold 1500. The mold 1500 includes a first portion 1502, which forms the cosmetic surfaces of the keycap, and a second portion 1504 which define a mold cavity 1510. In the example of FIG. 15, one or more optical layers 1508 may be pre-inserted into the mold cavity 1510. In one example, a turning layer (e.g., turning film) may be pre-inserted into the mold cavity 1510. In another example, a light control layer may be inserted above the turning layer. In yet another example, a diffusing layer may be inserted above the turning layer. In still another example, a diffusing layer may be inserted above a light control layer which is inserted above a turning layer. These are but examples—layers in other orders are contemplated by this disclosure, as well as pre-insertion of layers provided effects other than those specifically discussed herein.

In any case, once one or more optical layers 1508 are pre-inserted into the mold cavity 1510, material is then injected into the mold cavity 1510 to bond with the at least one or more of the optical layers 1508. It should be understood that the particular materials for the pre-inserted layers and the injected material will be chosen so as to provide adequate bonding.

FIG. 16 shows an exploded cross-sectional view of an example of a mold 1600 for making a keycap, where a molded keycap 1606 produced by the mold 1600 is included on the mold 1600. The mold 1600 includes a mold portion 1602. In the example of FIG. 16, the mold portion 1602 includes a pattern 1604 that may be embossed, or micro-embossed, in the keycap 1606, as will be described in greater detail below.

In the example of FIG. 16, a pre-molded keycap may be inserted onto the mold form 1610. In some embodiments, the mold portion 1602 may be heated to a predetermined temperature and pressed into an underside of the pre-molded keycap 1606. In this manner, the pattern 1604 is embossed onto an underside of the keycap 1606 thereby forming an optical layer 1608 which provides an optical effect. For example, the optical layer 1608 may be configured to turn upwardly-directed light from the display device so as to enhance oblique-angle through-key viewing of the imagery generated by the display device. In such an example, the mold portion 1602 forms a turning film or layer (e.g., a small series of turning prisms) in the underside of the keycap 1606.

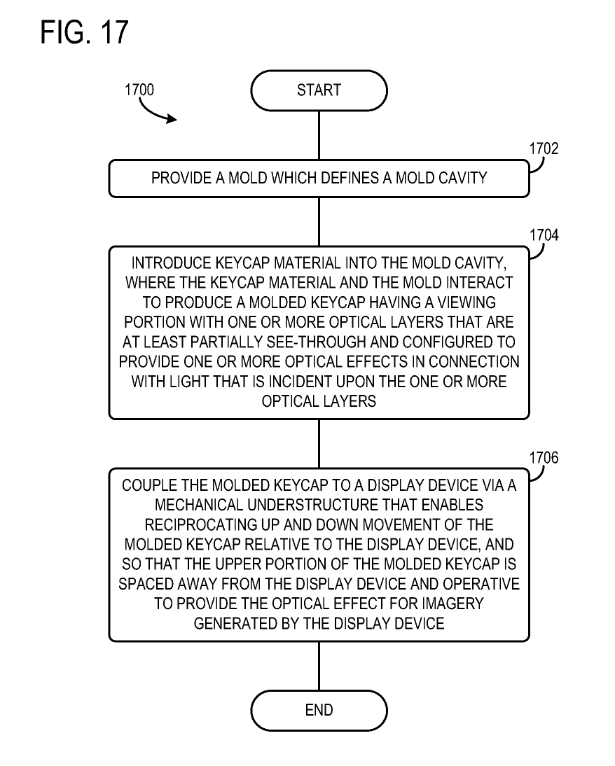

FIG. 17 shows an exemplary method 1700 of making an interactive keyboard in which a plurality of mechanically-depressible keys are situated over a display device, each of the mechanically-depressible keys being configured to permit through-key viewing of images produced by the underlying display device.

At 1702 of method 1700, a mold is provided which forms a mold cavity. The mold may have a first portion and a second portion, as depicted in FIGS. 14 and 15. Method 1700 of FIG. 17 further includes introducing keycap material into the mold cavity at 1704. The keycap material and the mold interact to produce a molded keycap having a viewing portion with one or more optical layers that are at least partially see-through. The optical layers may be configured to provide one or more optical effects in connection with light that is incident upon the one or more optical layers.

At 1706 of method 1700, the molded keycap is coupled to a display device via a mechanical understructure, such as mechanical understructure 414 described above with reference to FIG. 4. The mechanical understructure may enable reciprocating up and down movement of the molded keycap relative to the display device. Further, the mechanical understructure may couple the molded keycap to the display device so that the viewing portion of the molded keycap is spaced away from the display device and operative to provide the optical effect for imagery generated by the display device, as described above. The mechanical understructure may take a variety of configurations. Examples include scissors stabilizing structures, various springs, rubber domes and other structures providing tactile feedback, etc.

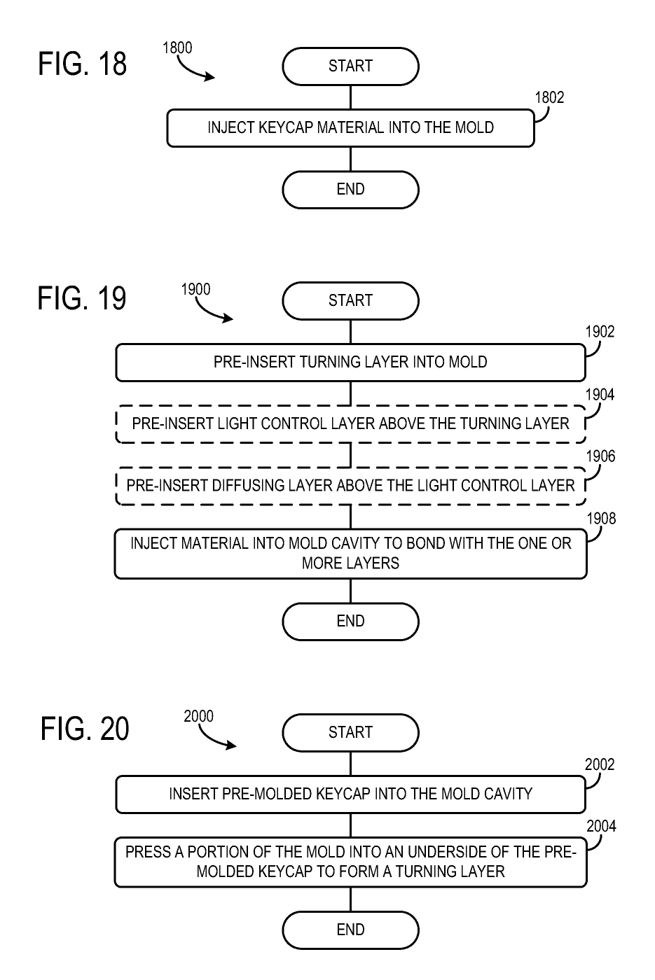

Method 1800 depicted in FIG. 18 shows an exemplary method of introducing keycap material into the mold cavity. Method 1800 may be used for making a keycap with the mold 1400 depicted in FIG. 14, for example. At 1802 of method 1800, the keycap material is injected into the mold. The keycap material may be polycarbonate or acrylic, for example. In such a configuration, the mold may form an optical pattern on an underside of the molded keycap to yield the turning film, as described above. In addition, as discussed above, various layers may be inserted into the mold prior to injection to provide effects in addition to that yielded through use of the optical pattern.

Method 1900 depicted in FIG. 19 shows another exemplary method of introducing keycap material into the mold cavity. Method 1900 may be used for making a keycap with the mold 1500 depicted in FIG. 15, for example. At 1902 of method 1900, a turning layer (e.g., turning film) is pre-inserted in the mold cavity. In some examples, a light control layer (e.g., light control film) is pre-inserted into the mold cavity above the turning layer at 1904 of method 1900. In some examples, at 1906, a diffusing layer (e.g., a diffuser) is inserted into the mold cavity above the light control layer, such that three optical layers are pre-inserted in the mold cavity. In other examples, the diffusing layer may be inserted into the mold cavity without a light control layer, such that two optical layers are pre-inserted in the mold cavity. In this way, the keycap may include at least one, two, or three optical layers. Also, the pre-insertion methods described in connection with FIG. 19 contemplate layers in addition to the specific layers described in the figure, and/or layers in a different sequence than the specific sequence detailed in the figure.

At 1908 of method 1900, material is injected into the mold cavity to bond with the one or more pre-inserted layers, and the upper layer of the keycap is formed. The material injected into the mold cavity may be compatible with the materials of the one or more layers such that physical and/or chemical bonds occur during the process. As an example, the material injected into the mold cavity may be the same material as at least one of the one or more layers (e.g., polycarbonate, acrylic, or the like).

Method 2000 depicted in FIG. 20 shows another exemplary method of introducing keycap material into the mold cavity. Method 2000 may be used for making a keycap with the mold 1600 depicted in FIG. 16, for example. At 2002 of method 2000, a pre-molded keycap is inserted into the mold cavity. The pre-molded keycap may include one or more optical layers, for example. In one example, the pre-molded keycap may have a diffusing layer. In another example, the pre-molded keycap may have light control layer and a diffusing layer, where the light control layer is below the diffusing layer. In some examples, the pre-molded keycap having one or more optical layers may be formed by a process such as method 1900 described above with reference to FIG. 19.

At 2004 of method 2000, a portion of the mold is pressed into the underside of the pre-molded keycap to form an optical layer, the optical layer being configured to provide an optical effect, such as a turning layer. In this manner, the mold micro-embosses a turning layer onto the underside of the keycap such that the turning layer is below one or more other optical layers in the keycap (e.g., light that is emitted from the display device passes through the turning layer first). In some embodiments, the portion of the mold may be heated, for example, to a melting or softening temperature of the underside of keycap.

Thus, a keycap which includes one or more optical layers configured to provide one or more optical effects may be manufactured via various methods. In one example, the keycap may be injection molded in one step. In another example, one or more optical layers may be pre-inserted in a mold cavity followed by injection of keycap material. In yet another example, an optical layer may be embossed on an underside of a pre-molded keycap. In this way, a computer peripheral with enhanced viewing characteristics may be constructed.

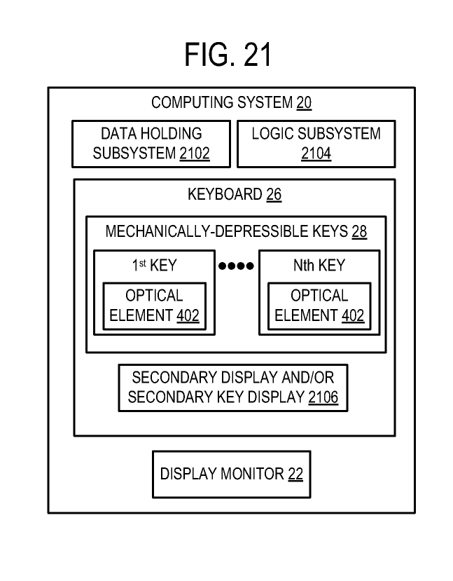

FIG. 21 schematically shows a nonlimiting computing system 20 having a computer peripheral including a display device underlying a plurality of mechanically-depressible keys, each key including an optical element. Computing system 20 is shown in simplified form. It is to be understood that virtually any computer architecture may be used without departing from the scope of this disclosure. In different embodiments, computing system 20 may include a mainframe computer, server computer, desktop computer, laptop computer, tablet computer, home entertainment computer, network computing device, mobile computing device, mobile communication device, gaming device, etc. Computing system 20 may also include computer peripherals such as keyboards, mice, game controllers, cameras, microphones, and/or touch screens, for example.

Specifically, exemplary computing system 20, as shown in FIG. 21, may include a data-holding subsystem 2102 containing instructions executable by a logic subsystem 2104 to control the display outputs of mechanically-depressible keys and appropriately respond to input signals generated as a result of key activation.

Logic subsystem 2104 may also include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 2104 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 2102 may include one or more physical, non-transitory devices configured to hold data and/or instructions executable by the logic subsystem to implement the methods and processes described herein. When such methods and processes are implemented, the state of data-holding subsystem 2102 may be transformed (e.g., to hold different data).

Data-holding subsystem 2102 may include removable media and/or built-in devices. Data-holding subsystem 2102 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 2102 may include devices with one or more of the following characteristics: volatile, nonvolatile, dynamic, static, read/write, read-only, random access, sequential access, location addressable, file addressable, and content addressable. In some embodiments, logic subsystem 2104 and data-holding subsystem 2102 may be integrated into one or more common devices, such as an application-specific integrated circuit or a system on a chip. As discussed above, the data-holding subsystem may be in the form of removable computer-readable storage media, which may be used to store and/or transfer data and/or instructions executable to implement the methods and processes described herein. Removable computer-readable storage media may take the form of CDs, DVDs, HD-DVDs, Blu-Ray Discs, EEPROMs, and/or floppy disks, among others.

Computing system 20 may include a computer peripheral such as keyboard 26. The computer peripheral may be configured to receive tactile user input via mechanical key depression and provide dynamic display output. As discussed above the computer peripheral may include a display device, such as secondary display and/or secondary key display 2106, and plurality of mechanically-depressible keys 28 situated over the display device. Each of the mechanically-depressible keys may be at least partially see-through to permit through-key viewing of imagery generated by the display device. It will be appreciated that the secondary display and/or secondary key display 2106 may be similar to display device 40, shown in FIGS. 1 and 2. The primary display may be display monitor 22 or a display device included in keyboard 26 spaced away from the mechanically-depressible keys. However, in other examples the computing system may not include a display monitor.

Additionally, each of the mechanically-depressible keys may include optical element 402 spaced from an operative surface of the display device and is configured to adjust viewer perception of image light emanating from the secondary display through the mechanically-depressible key. Optical element 402 may include at least one of a diffuser, a turning film, and a light control film. Specifically in some examples, a multi-layer construction may be utilized in which two or more of the aforementioned optical components (i.e., diffuser, turning film, light control film) are utilized.

The terms “module,” “program,” and “engine” may be used to describe an aspect of computing system 20 that is implemented to perform one or more particular functions. In some cases, such a module, program, or engine may be instantiated via logic subsystem 2104 executing instructions held by data-holding subsystem 2102. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of making an interactive keyboard, in which a plurality of mechanically-depressible keys are situated over a display device, each of the mechanically-depressible keys being configured to permit through-key viewing of images produced by the display device, the method comprising;
providing a mold which defines a mold cavity;
introducing keycap material into the mold cavity, where the keycap material and the mold interact to produce a molded keycap having a viewing portion with one or more optical layers that are at least partially see-through and configured to provide one or more optical effects in connection with light that is incident upon the one or more optical layers; and
coupling the molded keycap to the display device via a mechanical understructure that enables reciprocating up and down movement of the molded keycap relative to the display device, and so that the viewing portion of the molded keycap is spaced away from the display device and operative to provide the optical effect for imagery generated by the display device.

2. The method of claim 1, wherein introducing keycap material into the mold cavity includes injecting the keycap material into the mold cavity, and wherein a portion of the mold forms an optical pattern to yield one of the one or more optical layers of the molded keycap.

3. The method of claim 2, wherein the optical pattern is configured to turn upwardly-directed light from the display device so as to enhance oblique-angle through-key viewing of the imagery generated by the display device.

4. The method of claim 1, wherein introducing keycap material into the mold cavity includes pre-inserting at least one of the one or more optical layers into the mold cavity and then injecting material into the mold cavity to bond with the at least one or more of the optical layers.

5. The method of claim 4, wherein pre-inserting at least one of the one or more optical layers includes pre-inserting a turning layer configured to turn upwardly-directed light from the display device so as to enhance oblique-angle through-key viewing of the imagery generated by the display device.

6. The method of claim 5, wherein pre-inserting at least one of the one or more optical layers includes pre-inserting a light control layer above the turning layer.

7. The method of claim 6, wherein pre-inserting at least one of the one or more optical layers includes pre-inserting a diffusing layer above the light control layer.

8. The method of claim 5, wherein pre-inserting at least one of the one or more optical layers includes pre-inserting a diffusing layer above the turning layer.

9. The method of claim 1, wherein introducing keycap material into the mold cavity includes inserting a pre-molded keycap into the mold cavity, the method further comprising pressing a portion of the mold into an underside of the pre-molded keycap to form a turning layer configured to turn upwardly-directed light from the display device so as to enhance oblique-angle through-key viewing of the imagery generated by the display device.

10. A method of making an interactive keyboard, in which a plurality of mechanically-depressible keys are situated over a display device, each of the mechanically-depressible keys being configured to permit through-key viewing of images produced by the display device, the method comprising;
providing a mold which defines a mold cavity;
introducing keycap material into the mold cavity, where the keycap material and the mold interact to produce a molded keycap having a viewing portion with a turning layer configured to turn upwardly-directed light from the display device so as to enhance oblique-angle through-key viewing of imagery generated by the display device; and
coupling the molded keycap to the display device via a mechanical understructure that enables reciprocating up and down movement of the molded keycap relative to the display device, and so that the viewing portion of the molded keycap is spaced away from the display device and operative to provide one or more optical effects for imagery generated by the display device.

11. The method of claim 10, wherein introducing keycap material into the mold cavity includes injecting material into the mold cavity, and wherein a portion of the mold forms the turning layer on an underside of the molded keycap.

12. The method of claim 10, wherein introducing keycap material into the mold cavity includes pre-inserting one or more optical layers into the mold, including the turning layer, and then injecting material into the mold cavity so as to bond with the one or more optical layers, the one or more optical layers being situated in the viewing portion of the molded keycap and configured to provide the one or more optical effects.

13. The method of claim 12, wherein pre-inserting one or more optical layers into the mold includes pre-inserting a light control layer above the turning layer.

14. The method of claim 13, wherein pre-inserting one or more optical layers into the mold includes pre-inserting a diffusing layer above the light control layer.

15. The method of claim 12, wherein pre-inserting one or more optical layers into the mold includes pre-inserting a diffusing layer above the turning layer.

16. The method of claim 10, wherein introducing keycap material into the mold cavity includes:
inserting a pre-molded keycap into the mold cavity, the method further comprising pressing a portion of the mold into an underside of the pre-molded keycap to form the turning layer.

17. A method of making an interactive keyboard, in which a plurality of mechanically-depressible keys are situated over a display device, each of the mechanically-depressible keys being configured to permit through-key viewing of images produced by the display device, the method comprising;
providing a mold which defines a mold cavity;
introducing keycap material into the mold cavity;
pressing a portion of the mold into the keycap material to form a molded keycap with an optical layer at a viewing portion of the molded keycap, the optical layer being configured to provide an optical effect;
coupling the molded keycap to the display device via a mechanical understructure that enables reciprocating up and down movement of the molded keycap relative to the display device, and so that the viewing portion of the molded keycap is spaced away from the display device and operative to provide the optical effect for imagery generated by the display device.

18. The method of claim 17, wherein the optical layer is a turning layer configured to turn upwardly-directed light from the display device so as to enhance oblique-angle through-key viewing of the imagery generated by the display device.

19. The method of claim 18, wherein introducing the keycap material into the mold cavity includes inserting a pre-molded keycap having a diffusing layer into the mold cavity, and wherein the portion of the mold is pressed into an underside of the pre-molded keycap to form the turning layer below the diffusing layer.

20. The method of claim 18, wherein introducing the keycap material into the mold cavity includes inserting a pre-molded keycap having a diffusing layer and a light control layer into the mold cavity, and wherein the portion of the mold is pressed into an underside of the pre-molded keycap to form the turning layer below the diffusing layer and the light control layer.
